(19) United States
(12) Patent Application Publication
(10) Pub. No.: US 2010/0138337 A1
(43) Pub. Date: Jun. 3, 2010

(54) MEDIA PURCHASE FROM WITHIN A VIDEO GAME ENVIRONMENT

(75) Inventors: Christopher R. Barnett, San Francisco, CA (US); Elwin Kongeang Sam, Tustin, CA (US); Geethika Uriti, Fremont, CA (US)

Correspondence Address: Cantor Colburn LLP - Fox Entertainment Group, 20 Church Street, 22nd Floor, Hartford, CT, 06103, US

(73) Assignee: FOX DIGITAL ENTERPRISES, INC., Los Angeles, CA (US)

(21) Appl. No.: 12/325,403

(22) Filed: Dec. 1, 2008

(51) Int. Cl. G06Q 40/00

(52) U.S. Cl. 705/39

(57) ABSTRACT

In one example, a media purchase system is provided. The media purchase system includes: a media manager module that selectively coordinates a media file with an operating scenario in a video game; a selection manager module that manages a selection of the media file for purchase in the video game; and a media purchase module that manages a purchase of the selection in the video game.

### FIELD

The present disclosure relates to methods, systems, and computer program products for purchasing media through a gaming environment.

### BACKGROUND

The statements in this section merely provide background information related to the present disclosure and may not constitute prior art.

Interactive audio-visual devices, such as video game consoles and video games themselves, provide entertainment for a user by engaging the user in an interactive game play. To improve the quality of the entertainment, video game designers have incorporated into the games popular media, such as, for example, music and/or music videos from various artists. In some cases, a user can even select a particular genre of the media to be coordinated with the game play. The media relating to that genre are then incorporated into the game play.

It has become increasingly popular for users to keep a personalized library of their favorite media files. When a particular media file of the video game is well-liked by a user, however, the user is unable to directly incorporate that media file into their personal library.

### SUMMARY

Accordingly, a media purchase system is provided. The media purchase system includes: a media manager module that selectively coordinates a media file with an operating scenario in a video game; a selection manager module that manages a selection of the media file for purchase in the video game; and a media purchase module that manages a purchase of the selection in the video game.

In another example, a method of managing a purchase of a media file is provided. The method includes: selectively coordinating a media file with an operating scenario of a video game; managing a selection of the media file for purchase through the video game; and managing a purchase of the selection through the video game.

Further areas of applicability will become apparent from the description provided herein. It should be understood that the description and specific examples are intended for purposes of illustration only and are not intended to limit the scope of the present disclosure.

### BRIEF DESCRIPTION OF THE SEVERAL VIEWS OF THE DRAWINGS

The drawings described herein are for illustration purposes only and are not intended to limit the scope of the present disclosure in any way. It should be understood that throughout the drawings, corresponding reference numerals indicate like or corresponding parts and features.

FIG. 1 is a block diagram illustrating a gaming system that includes a media purchase system in accordance with an exemplary embodiment of the present disclosure.

FIG. 2 is a dataflow diagram illustrating a gaming application of the media purchase system of FIG. 1 in accordance with an exemplary embodiment of the present disclosure.

FIG. 3 is a dataflow diagram illustrating a media purchase manager application of the media purchase system of FIG. 1 in accordance with an exemplary embodiment of the present disclosure.

FIG. 4 is a flowchart illustrating a media purchase method that can be performed by the media purchase system of FIG. 1 in accordance with an exemplary embodiment.

### DETAILED DESCRIPTION

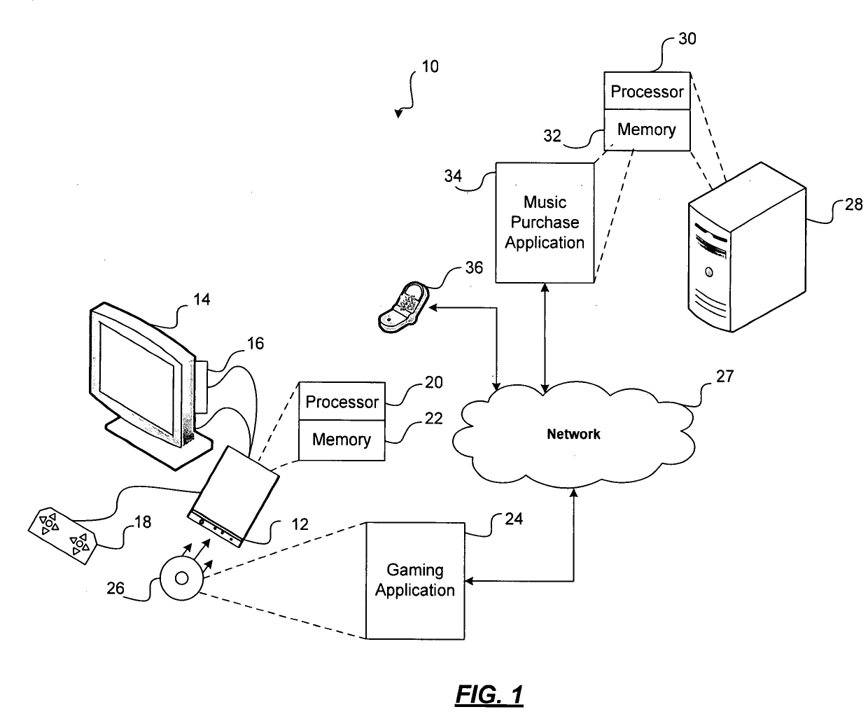

Turning now to the drawings in greater detail, it will be seen that in FIG. 1 an exemplary gaming system 10 includes a media purchase system of the present disclosure. The exemplary gaming system 10 is shown to include a game console 12 that is associated with a display device 14, an audio device 16, and one or more input devices 18. The one or more input devices 18 can be used by a user to communicate with the game console 12. As can be appreciated, such input devices 18 can include, but are not limited to, a game controller including, for example, a joystick, a keypad, and/or a touchpad. The display device 14 and the audio device 16 are used to communicate video and audio signals respectively from the game console 12 to the user. As can be appreciated, such display device 14 and audio device 16 can be incorporated into, for example, a television, a desktop computer, a laptop, a cell phone, and/or a personal handheld device.

The game console 12 includes a processor 20 and memory 22. The memory 22 can be at least one of random access memory (RAM), read only memory (ROM), a cache, a stack, or the like which may temporarily or permanently store electronic data of the game console 12. The processor 20 is operable to execute one or more sets of instructions contained in a software application.

A gaming application 24 can be installed to the memory 22 of the game console 12, run by the game console 12 from a portable storage device 26, such as, for example, a CD-ROM as shown in FIG. 1, and/or downloaded or run from a remote location such as, for example, from a remote server 28. The gaming application 24 controls the operation of a video game in response to user input received from the input devices 18. Based on the operation of the video game, the gaming application 24 generates video signals to the display device that include graphics associated with the video game and generates audio signals to the audio device that include sounds, music, and/or speech associated with the video game. The gaming application 24 is further operable to facilitate the selection of media files for purchase during the operation of the video game.

In various embodiments, the gaming system 10 further includes a remote server 28. The remote server 28 similarly includes a processor 30 and memory 32. The memory 32 can similarly be at least one of random access memory (RAM), read only memory (ROM), a cache, a stack, or the like which may temporarily or permanently store electronic data of the remote server 28. The processor 30 is similarly operable to execute one or more sets of instructions contained in a software application.

A media purchase application 34 can be installed to the memory 32 of the remote server 28 as shown in FIG. 1, installed to the memory 22 of the game console 12, and/or run by the game console 12 from the portable storage device 26. The media purchase application 34 is operable to communicate with the gaming application 24 to facilitate the purchase of a copy of the selected media file. In various embodiments, the media purchase application 34 communicates with the gaming application 24 via a network 27 and according to a network protocol, such as, for example, TCP/IP, HTTP, USB, Wi-Fi, and Bluetooth.

Once the purchase of the selected media file is complete, the media purchase application 34 communicates the copy of the purchased media file to a remote storage location 36, such as, for example, a cell phone, a personal handheld device, a laptop, a desktop, and/or any other device for personal use by the user.

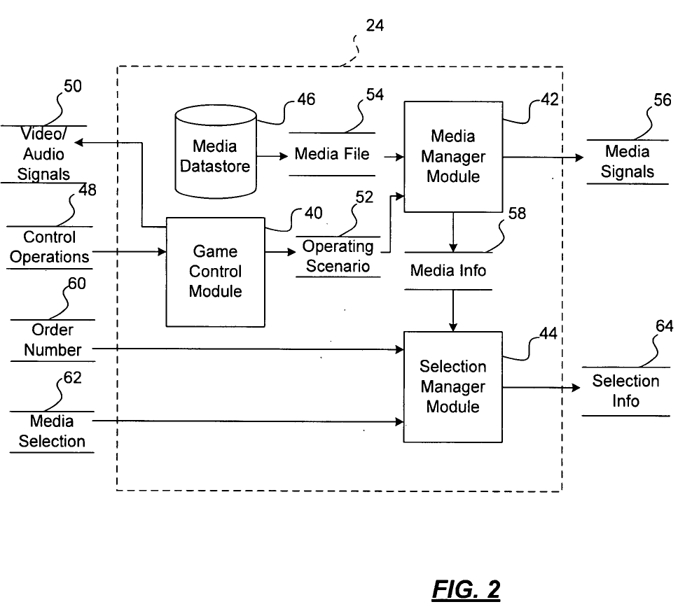

Turning now to FIG. 2, the gaming application 24 is shown in more detail in accordance with an exemplary embodiment. The gaming application 24 includes one or more modules and datastores. In various embodiments, the modules can be implemented as software (as described above), hardware, firmware and/or other suitable components that provide the described functionality. As can be appreciated, the modules shown in FIG. 2 can be combined and/or further partitioned to similarly control the operation of the video game and to facilitate the selection of the media file for purchase. In this example, the gaming application 24 includes a game control module 40, a media manager module 42, a selection manager module 44, and a media datastore 46.

The game control module 40 receives as input control operations 48 generated by the input devices 18 (FIG. 1) based on the user's interactions with the input devices 18 (FIG. 1). Based on the control operations 48, the game control module 40 controls the operation of the video game and generates video and/or audio signals 50 accordingly. The game control module 40 further monitors the current operating conditions of the video game and determines an operating scenario 52. For example, the current operating conditions are compared with predetermined operating conditions to determine the operating scenario 52.

The media manager module 42 receives as input the operating scenario 52. Based on the operating scenario 52, the media manager module 42 interfaces with the media datastore 46. The media datastore 46 stores a library of various media files 54. In one example, the media files 54 include various music and/or music videos. In this example, the media manager module 42 retrieves a specific song and/or music video based on the current operating scenario 52. Based on the retrieved media file 54, the media manager module 42 generates a media signal 56. The media signal 56 is generated to the display device 14 (FIG. 1) and/or the audio device 16 (FIG. 1). As can be appreciated, the media datastore 46 can store any media including, but not limited to, music, music videos, movies and movie clips, and stores the media in any format.

The media manager module 42 further makes available media information 58 relating to the retrieved media file 54. In the example of the media file 54 being music and/or a music video, the media information 58 can include, for example, a title, a version, an artist, and/or a listing of related media. The media manager module 42 can extract the media information 58 from, for example, meta-data associated with the media file 54.

The selection manager module 44 receives as input the media information 58, an order number 60, and/or a media selection 62. The order number 60 and the media selection 62 can be generated by the input devices 18 (FIG. 1) based on a user's interactions with the input devices 18 (FIG. 1). In one example, the order number 60 can be a purchase request number that is entered by a user via the input devices 18 (FIG. 1) interacting with the video game. For example, the order number is a phone number entered into a virtual cell phone of the video game. In another example, the order number is a unique confirmation number that identifies a particular user. For example, the order number is a personal password.

The selection manager module 44 verifies the order number 60. Once the order number 60 has been verified, the selection manager module 44 manages the selection entered by the user via the media selection 62. In various embodiments, the media selection 62 refers to the current media that has been retrieved by the media manager module 42. In various other embodiments, the selection manager module 44 generates a listing of media related to the current media file 54 based on the media information 58 and the media selection 62 refers to a particular media file from the listing.

Based on the media selection, the selection manager module 44 generates selection information 64. The selection information 64 includes, for example, the media information 58 and, optionally, user information.

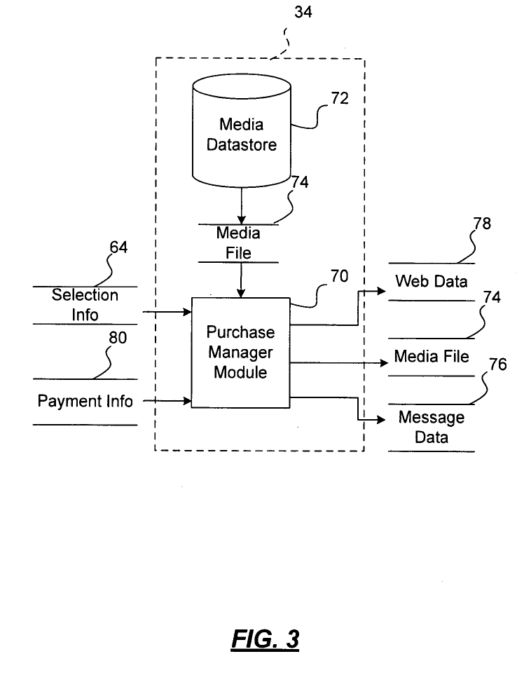

Turning now to FIG. 3, the media purchase application 34 is shown in more detail in accordance with an exemplary embodiment. The media purchase application 34 includes one or more modules and datastores. In various embodiments, the modules can be implemented as software (as described above), hardware, firmware and/or other suitable components that provide the described functionality. As can be appreciated, the modules shown in FIG. 3 can be combined and/or further partitioned to similarly facilitate the purchase of the selected media file. In this example, the media purchase application 34 includes a purchase manager module 70 and, optionally, a media datastore 72.

The purchase manager module 70 receives as input the selection information 64. Based on the selection information 64, the purchase manager module 70 manages the purchase of a copy of a selected media file 74. As can be appreciated, the purchase manager module 70 can perform the purchase transaction itself, refer the purchase to a web-based entity (e.g., amazon.com), and/or refer to a user the web-based entity capable of performing the purchase transaction.

In one example, based on the selection information 64, the purchase manager module 70 generates an email, a text message, and/or an instant message via message data 76 that includes a link to the web-based entity for purchasing the copy of the media file 74. In another example, the purchase manager module 70 interfaces with the web-based entity via web data 78 to perform the initial steps of the purchase required by the web-based entity. Such initial steps can include, for example, selecting a name of the media file and placing the name of the media file in a shopping cart. The purchase manager module 70 then generates an email, a text message and/or an instant message via the message data 76 that includes a link to a more advanced stage of the web-entity.

In yet another example, the purchase manager module 70 performs the purchase transaction by accepting payment information 80 (e.g., credit card information, billing address, email address, etc.) and interfaces with the media datastore 72 to retrieve the copy of the selected media 74. In various embodiments, the media datastore 72 is the same as the media datastore 46. In various other embodiments, the media datastore 72 is a separate datastore that stores the media made available through the gaming application as well as other media. In this example, the purchase manager module 70 generates an email including the purchased media file 74 or generates an email, a text message, and/or an instant message including a link to download the copy of the purchased media file from the media datastore 72.

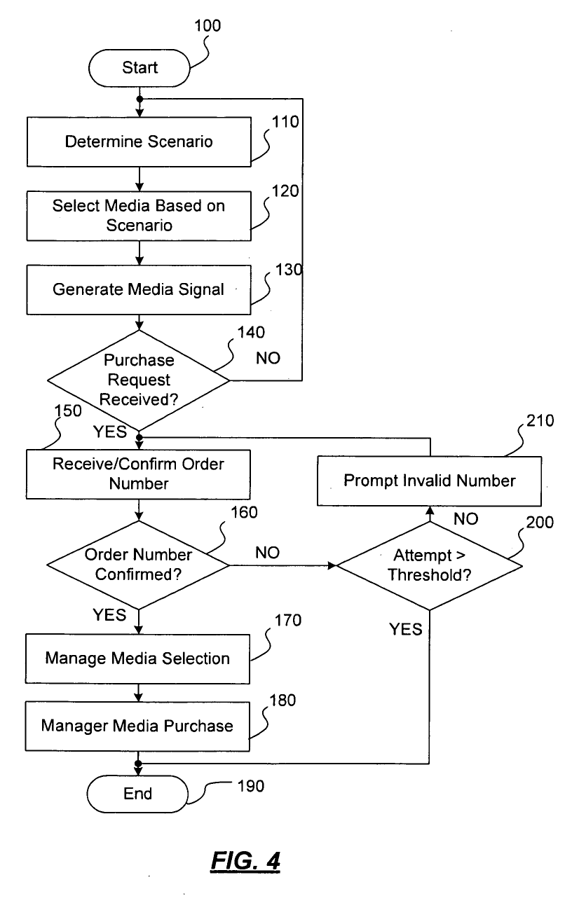

Turning now to FIG. 4, a media purchase method that can be performed by the media purchase system of FIG. 1 is shown in accordance with an exemplary embodiment. As can be appreciated in light of the disclosure, the order of operation within the method is not limited to the sequential execution as illustrated in FIG. 4, but may be performed in one or more varying orders as applicable and in accordance with the present disclosure.

In one example, the method may begin at 100. The operating scenario is determined based on the operating conditions at 110. In one example, the video game is an action-adventure game that includes an avatar that navigates through an environment by foot and/or by vehicle. While in the vehicle for example, the avatar can select a particular radio station. When selected, the radio station plays a specific genre of music. The operating conditions are monitored to determine the operating scenario to include, for example, that a particular radio station has been selected.

The media is selected based on the operating scenario at 120 and the media signal for the selected media is generated at 130. Purchase requests are monitored at 140. If a purchase request is received at 140, the order number and/or the user is verified at 150. If the order number and/or the user is successfully verified at block 160, the media file selection is managed at block 170. In one example, the selected media is the current media selected based on the operating scenario. In another example, the media is selected from the listing of media relating to at least one of the current operating scenario and/or in general, the gaming application.

At 180, the purchase of the selected media is managed as discussed earlier. In one example, the purchase information is received and verified and a media file is made available to the user by, for example, email. Thereafter, the method may end at 190.

If, however, the order number is not successfully verified at 160 and a verification attempt is less than an attempt threshold (e.g., two) at 200, a prompt to re-enter the order number is generated at 210. The newly entered order number is received at 150 and verified at 160. If, however, the verification attempt exceeds the attempt threshold at 200, a notification can be sent indicating an invalid number at 220 and the method may end at 190.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

Computer program code for carrying out operations of the present invention may be written in any combination of one or more programming languages, including an object oriented programming language such as XML, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A media purchase system, the system comprising:
a media manager module that selectively coordinates a media file with an operating scenario in a video game;
a selection manager module that manages a selection of the media file for purchase in the video game; and
a media purchase module that manages a purchase of the selection in the video game.

2. The system of claim 1 wherein the media purchase module manages the purchase of the selection by managing an actual purchase transaction relating to the selection and making available a copy of the media file relating to the selection to a user.

3. The system of claim 1 wherein the media purchase module manages the purchase of the selection by interacting with a media sale entity to coordinate the purchase of the selection.

4. The system of claim 1 wherein the media purchase module manages the purchase of the selection by generating an electronic notification to a user indicating the media sale entity from which to purchase the selection.

5. The system of claim 4 wherein the generating the electronic notification is in the form of at least one of an email, a text message, and an instant message.

6. The system of claim 1 further comprising a media datastore that stores the media file and a plurality of other media files.

7. The system of claim 6 wherein the media manager module coordinates each of the plurality of media files from the media datastore with operating scenarios of the video game.

8. The system of claim 7 wherein the purchase manager module manages the purchase of the media file from the media datastore.

9. The system of claim 1 wherein the media manager module and the selection manager module reside on a first storage device and the purchase manager module resides on a second storage device and wherein the selection manager module and the purchase manager module communicate through a network.

10. The system of claim 1 wherein the media files are at least one of music files and video files.

11. A method of managing a purchase of a media file, the method comprising:
selectively coordinating a media file with an operating scenario of a video game;
managing a selection of the media file for purchase through the video game; and
managing a purchase of the selection through the video game.

12. The method of claim 11 wherein the managing the purchase of the selection comprises managing an actual purchase transaction relating to the selection and making available a copy of the media file relating to the selection to a user.

13. The method of claim 11 wherein the managing the purchase of the selection comprises managing the purchase by interacting with a media sale entity to coordinate the purchase of the selection.

14. The method of claim 11 wherein the managing the purchase of the selection comprises managing the purchase by generating an electronic notification to a user indicating the media sale entity from which to purchase the selection.

15. The method of claim 14 wherein the generating the electronic notification is in the form of at least one of an email, a text message, and an instant message.

16. The method of claim 11 further comprising retrieving the media file from a media datastore that stores the media file and a plurality of other media files.

17. The method of claim 16 wherein the selectively coordinating the media file with the operating scenario of the video game is based on the retrieving of the media file from the media datastore.

18. The method of claim 17 wherein the managing the purchase of the media file is based on the retrieving of the media file from the media datastore.

19. The method of claim 11 wherein the media files are at least one of music files and video files.
